(19) United States
(12) Patent Application Publication
(10) Pub. No.: US 2015/0234591 A1
(43) Pub. Date: Aug. 20, 2015

(54) APPARATUS AND METHOD FOR DISPLAYING KEYPAD OF ELECTRONIC DEVICE

(71) Applicant: Samsung Electronics Co., Ltd., Gyeonggi-do (KR)

(72) Inventors: Yongman Park, Gyeonggi-do (KR); Wonjae Lee, Gyeonggi-do (KR)

(21) Appl. No.: 14/624,284

(22) Filed: Feb. 17, 2015

(30) Foreign Application Priority Data
Feb. 17, 2014 (KR) 10-2014-0017775

(51) Int. Cl. G06F 3/0488; G06F 3/041

(52) U.S. Cl. CPC G06F 3/04886; G06F 3/041; G06F 2203/04803

(57) ABSTRACT

An apparatus and a method for providing a keypad for an electronic device. The method of displaying a keypad of an electronic device includes when the display of a screen is requested, identifying whether a keypad cover is open or closed, in response to the keypad cover closed, displaying a key array on the keypad cover, receiving a touch input detected on the displayed key array, and processing the detected touch input to display the touch input on the screen. The disclosure provides a convenient input scheme by switching screen display modes according to an open/closed state of the keypad cover.

### CROSS-REFERENCE TO RELATED APPLICATION AND CLAIM OF PRIORITY

The present application is related to and claims priority from and the benefit under 35 U.S.C. §119(a) of Korean Patent Application 10-2014-0017775, filed on Feb. 17, 2014, which is hereby incorporated by reference for all purposes as if fully set forth herein.

### TECHNICAL FIELD

The present disclosure relates to an apparatus and a method for displaying a keypad mounted to an electronic device.

### BACKGROUND

Portable terminals have been recently developed to include a touch screen for displaying various User Interfaces (UIs). The touch screen receives a user input for a User Interface (UI). In order to determine user input, change in electrostatic capacity in the touch screen or change in the infrared rays due to user input is monitored and detected.

An electronic device may include a keypad cover to protect a touch screen, and may detect an open or closed state of the keypad cover though a magnetic substance. Here, the keypad cover is a flip type cover on one surface, which may be attached and connected to the rear surface of the electronic device.

### SUMMARY

The keypad cover that is mounted to an electronic device should be opened when a letter is written or when a specific function is performed. For example, when a phone call is dialed or a short text message is written while the keypad cover is closed, one side surface of the keypad cover should be opened. The keypad cover should be opened whenever a letter or a number is inputted.

To address the above-discussed deficiencies, it is a primary object to provide an apparatus and a method for displaying a keypad on a screen in which a transparent cover having a conductive material is connected to one surface of an electronic device having a touch screen, which faces the touch screen when the keypad cover is closed and the keypad corresponds to an open or closed state of the keypad cover. The electronic device displays a set keypad screen if the keypad cover is in an opened state and displays a set keypad screen on the keypad cover if the keypad cover is in a closed state, and the conductor material of the keypad cover may be formed according to the arrangement of the keypad screen. The keypad cover may be a flip type keypad cover apparatus on one side surface, which may be attached and connected to the rear surface of the electronic device.

Furthermore, the present disclosure proposes an apparatus and a method for displaying an arrangement of a keypad on a screen in which keypads having various designs and layouts can be provided from a third party business through various forms of keypad covers, and keypad layouts can be identified in an electronic device when the keypad cover is mounted.

In accordance with one aspect of the present disclosure, the method for displaying a keypad for an electronic device includes upon a display event on a screen of the electronic device, identifying whether a keypad cover is open or closed, in response to the keypad cover being closed, displaying a keypad corresponding to a key array of keypad cover, and receiving a touch input detected on the displayed keypad, and processing the detected touch input to display the touch input on the screen.

In accordance with another aspect of the present disclosure, a method for displaying a keypad of the keypad cover includes identifying one of an open or a closed state of the keypad cover,in response to the keypad being closed, transmitting keypad information having a key array to the electronic device by the keypad cover.

In accordance with yet another aspect of the present disclosure, an apparatus for displaying a keypad includes a keypad cover comprising a front surface formed of a transparent material and conductors disposed in a key array, for detecting a signal obtained through a touch on the keypad cover, and a rear surface formed of an opaque material and mounted to the rear surface of the electronic device,a sensor configured to detect one of an open and a closed states of the keypad cover, a touch panel configured to detect a user input made through a touch on the keypad cover or the display panel,a display panel configured to display an execution screen and a keypad, and a controller configured to display a keypad set in the electronic device on the display unit when the keypad cover is opened, display a keypad corresponding to the key array on the keypad cover when the keypad cover is closed, and p process a touch input detected by the touch panel.

An electronic device according to an embodiment of the present disclosure may detect user input while the keypad cover is closed. Here, the keypad cover is a flip type cover including a keypad, and one side surface of the keypad cover may be coupled and connected to an electronic device. The electronic device including the keypad cover can display a screen in a method optimized for a specific purpose according to an opened and closed state of the keypad cover.

In addition, the electronic device, according to an embodiment of the present disclosure, can provide a function of conveniently making a user input using a haptic feeling through the keypad cover including a physical button. Accordingly, typos can be reduced.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram schematically illustrating a configuration of an electronic device including a keypad cover according to an embodiment of the present disclosure;

FIG. 2 is a block diagram schematically illustrating a configuration of an electronic device according to an embodiment of the present disclosure;

FIGS. 3A to 3C are diagrams schematically illustrating a configuration of a keypad cover according to an embodiment of the present disclosure;

FIG. 4 is a flowchart illustrating a procedure of displaying a screen according to an open/closed state of a keypad cover in an electronic device according to an embodiment of the present disclosure;

FIGS. 5A to 5C is a flowchart illustrating an example of displaying a screen according to an open/closed state of a keypad cover in an electronic device according to an embodiment of the present disclosure; and

FIG. 6 is a flowchart illustrating a procedure of transmitting information of the keypad cover according to an open/closed state of the keypad cover according to another embodiment of the present disclosure.

### DETAILED DESCRIPTION

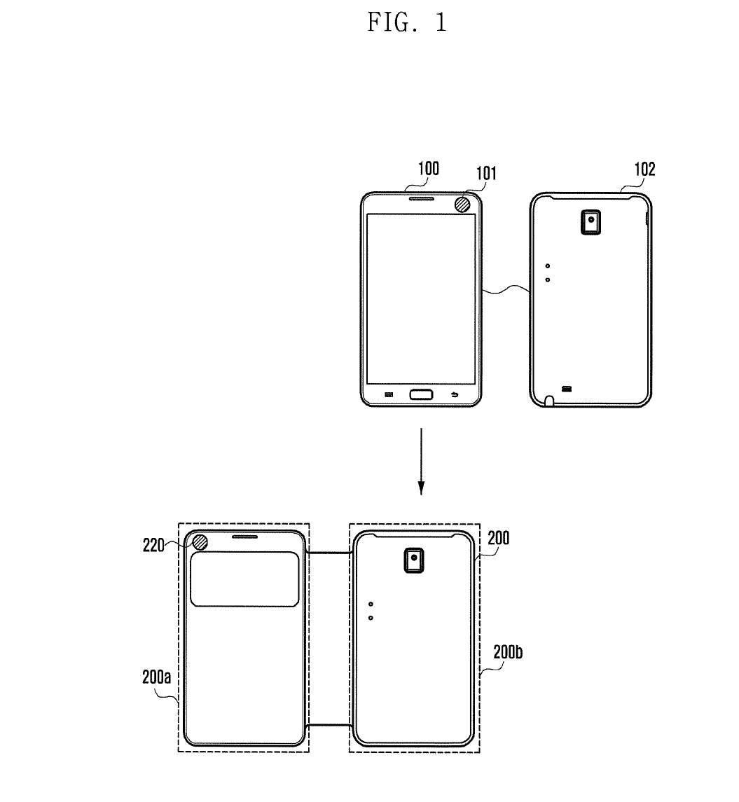

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, various embodiments of the present disclosure will be described with reference to the accompanying drawings. It should be noted that the same elements will be designated by the same reference numerals although they are shown in different drawings. Further, a detailed description of a known function and configuration which may make the subject matter of the present disclosure unclear will be omitted. Hereinafter, it should be noted that only the descriptions will be provided that may help understanding the operations provided in association with the various embodiments of the present disclosure, and other descriptions will be omitted to avoid making the subject matter of the present disclosure rather unclear.

An electronic device according to various embodiments of the present disclosure includes a touchscreen, and a keypad cover for protecting the display unit of the electronic device, may be connected to the touch screen. The keypad cover may be formed of a transparent material, and conductors may be disposed on one surface of the keypad cover which faces the touchscreen when the cover is closed. The conductors may be piezoelectric elements, and the piezoelectric elements may be disposed in the same way as a layout of the keypad. For example, the piezoelectric elements of the keypad cover may be disposed in a 4*3 key array, a QWERTY key array, or a key array for a specific application (for example, a game).

In an electronic device according to various embodiments of the present disclosure, a keypad for inputting data and instructions when a keypad cover is opened may be displayed on a display unit in the form of a keypad set in the electronic device. When the keypad cover is closed, the electronic device may identify an array of piezoelectric elements of the keypad cover and display a keypad corresponding to the identified array. If a user input occurs in the keypad cover of a transparent material, the electronic device may detect a location where the user input occurs using the piezoelectric elements of the keypad cover.

The electronic device according to the various embodiments of the present disclosure may display keypads which are set according to an open/closed state of the keypad on the display unit. For example, when the keypad cover is opened, the electronic device may display a keypad (for example, a keypad of a smartphone) of the electronic device, and when the keypad cover is closed, the electronic device may display a keypad (for example, a keypad of a feature phone) corresponding to the keypad cover.

In the following description, the term ‘a keypad cover’ may refer to a keypad cover apparatus that may be coupled to an electronic device, and one surface (rear surface) thereof is attached and connected to the rear surface of the electronic device. The keypad cover may be in the form of a flip.

FIG. 1 is a diagram schematically illustrating a configuration of an electronic device including a keypad cover according to an embodiment of the present disclosure.

Referring to FIG. 1, an electronic device 100 can be attached and coupled to a keypad cover 200. In an embodiment of the present disclosure, an electronic device 100 can be attached and coupled to a battery cover 102. The battery cover 102 is used instead of the keypad cover 200 for covered a rear surface of the electronic device 100. The keypad cover 200 is used instead of the battery cover 102 for covered a rear surface of the electronic device 100. The electronic device 100 can include a keypad cover information receiver 101. Here, the keypad cover information receiver 101 receives keypad information corresponding to a key array from the coupled keypad cover 200. The battery cover 102 can be attached to and detached from a rear surface of the electronic device 100.

The electronic device 100 can be attached and coupled to the keypad cover 200 while a battery cover 102 is detached from the electronic device 100. Then, a rear surface of the electronic device 100 and a rear surface 200b of the keypad cover can be attached and coupled to each other.

The keypad cover 200 can include a front surface 200a and a rear surface 200b. The rear surface 200b of the keypad cover can be attached and coupled to the rear surface of the electronic device while supporting the coupled electronic device 100, and the front surface 200a can open and close one side surface of the electronic device 100 with respect to a corner of the one side surface of the electronic device 100. The front surface 200a of the keypad cover 200 can include a communication unit 220. If the keypad cover 200 is closed (that is, the keypad cover 200 covers one side surface (the touch screen 130) of the electronic device 100, the communication unit 220 serves to transmit information of the keypad cover to the electronic device 100. Here, the keypad cover information is layout information of various keypads, and, for example, can be layout information of a QWERTY keypad, a 4*3 keypad, and keypads of various input schemes. If the electronic device 100 and the keypad cover 200 are coupled to each other, the communication unit 220 transmits keypad cover information to the electronic device 100.

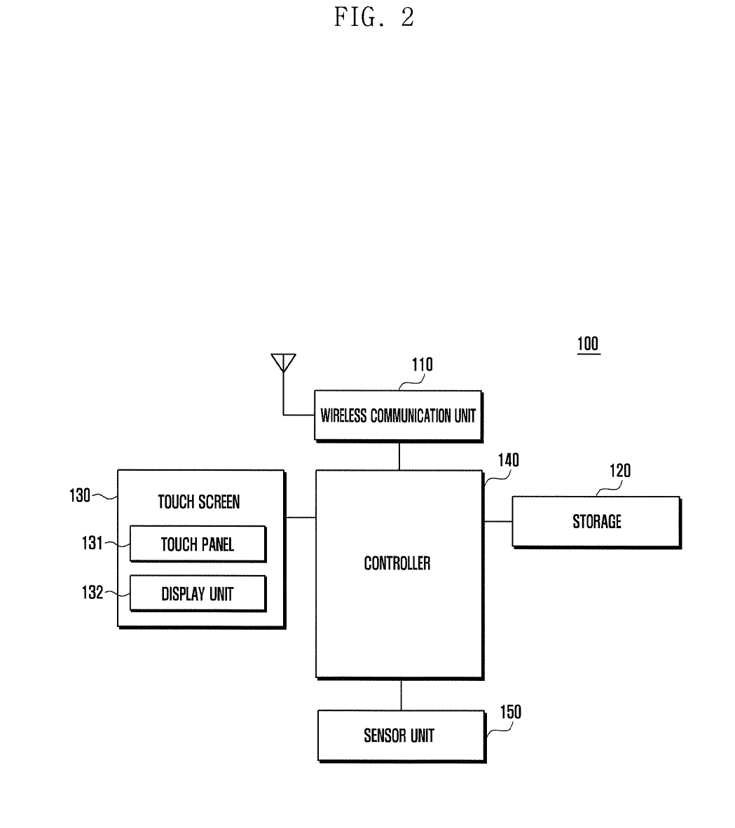

FIG. 2 is a block diagram schematically illustrating a configuration of an electronic device according to an embodiment of the present disclosure.

Referring to FIG. 2, the electronic device 100 can include a wireless communication unit 110, a storage 120, a touch screen 130, a controller 140, and a sensor unit 150. The components of FIG. 2 are not essential, but can be implemented by a larger number of components or a smaller number of components. For example, when the electronic device 100 according to an embodiment of the present disclosure does not support a separate communication function, the wireless communication unit 110 can be omitted.

The wireless communication unit 110 can include a keypad cover information receiver 101 of FIG. 1. The wireless communication unit 110 can include one or more modules which enables wireless communication between the electronic device and a wireless communication system or the electronic device and a network including another electronic device. For example, the wireless communication unit 110 can include a mobile communication module, a Wireless Local Area Network (WLAN) module, a short-range communication module, a location calculating module, a broadcast receiving module and the like.

The keypad cover information receiver 101 can receive keypad cover information from the keypad cover 200. Here, the keypad is a keypad layout corresponding to a keypad included in the keypad cover 200. The keypad cover information receiver 101 can receive information using a short range wireless communication technology. The short range wireless communication technology can be, for example, Near Field Communication (NFC), but the present disclosure is not limited thereto.

The storage 120 can store a program for the electronic device 100. The storage 120 can store a layout of a virtual keypad corresponding to the keypad cover information.

The touchscreen 130 can include a touch panel 131 and a display panel 132. When the keypad cover 200 is closed, the touch panel 131 detects the user input made through the keypad cover, and processes the user input through key data. Here, the user input can be made by pushing the keypad provided in the keypad cover. If the keypad cover is opened, the touch panel 131 can display a keypad set in the electronic device 100 and detect user input. Here, the user input can be a touch, a tap, a drag, a flip, a scroll, a zoom-in, or a zoom-out.

The display panel 132 can be an LCD or an OLED. If the keypad cover 200 is closed, the display panel 132 can display an execution screen in one area and can display a keypad corresponding to a key array mounted to another area. Here, the execution screen can be, for example, a screen for displaying a clock in an idle state when the display of a screen is requested, a screen for displaying the reception of a voice communication or a message when the voice communication or the message is received, a screen for displaying music when music is reproduced, and a screen for displaying an alarm when a push alarm is requested. Furthermore, the execution screen can be a screen for displaying input contents when user input is detected through the virtual keypad. Meanwhile, if the keypad cover 200 is opened, the display panel 132 can display an execution screen in the entire area. Here, the execution screen can be a screen (for example, an application execution screen) on which a function corresponding to a user input is executed, and can be a screen for displaying a set keypad.

The sensor unit 150 can include various sensors necessary for driving the electronic device. In particular, according to the present disclosure, the sensor unit 150 can detect an open/closed state of the keypad cover 200 including a magnetic substance.

The controller 140 controls the overall operation of the electronic device. If a request for the display of a screen is detected in an idle state, the controller 140 identifies an open/closed state of the keypad cover 200. Then, the front surface 200a can include an open area in a region, and can include a closed area in another region. The closed area can include a keypad. The controller 140 can display different screens according to an open/closed state of the keypad cover 200. When the keypad cover 200 is closed, an execution screen responding to a user input can be displayed in an area (that is, an area corresponding to the open area of the front surface 200a) of the displayed screen and a keypad can be displayed in another area (a keypad area of the front surface 200a). Then, the displayed keypad is a keypad having the same layout as that of the mounted keypad cover. If a user input made on the keypad is detected, the controller 140 processes the user input with key data. When the keypad cover 200 is open (the keypad cover 200 is opened), an execution screen responding to the user input can be displayed in the entire area of the displayed screen and a keypad set in the electronic device 100 can be displayed.

This way, if the keypad cover 200 is closed, the controller 140 can display a keypad corresponding to the key array of the mounted keypad cover and an execution screen. If the keypad cover 200 is opened, the controller 140 can display a keypad set in the electronic device and an execution screen responding to a user input.

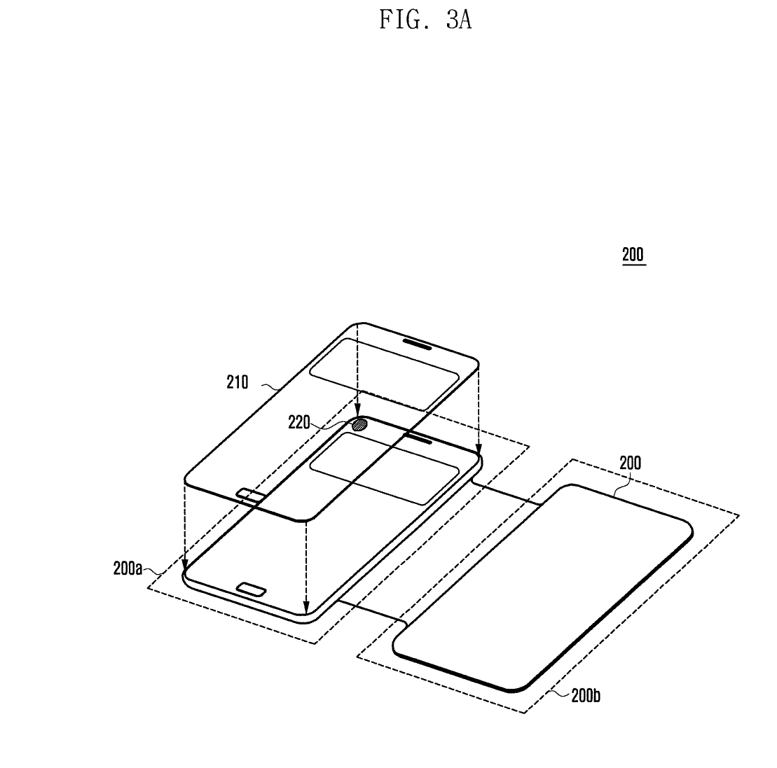

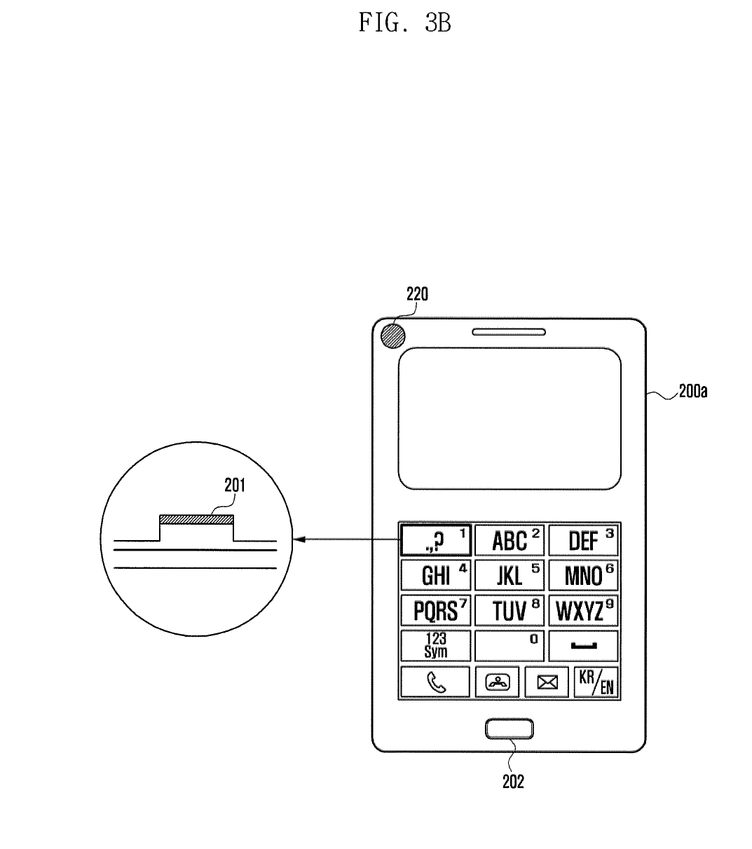

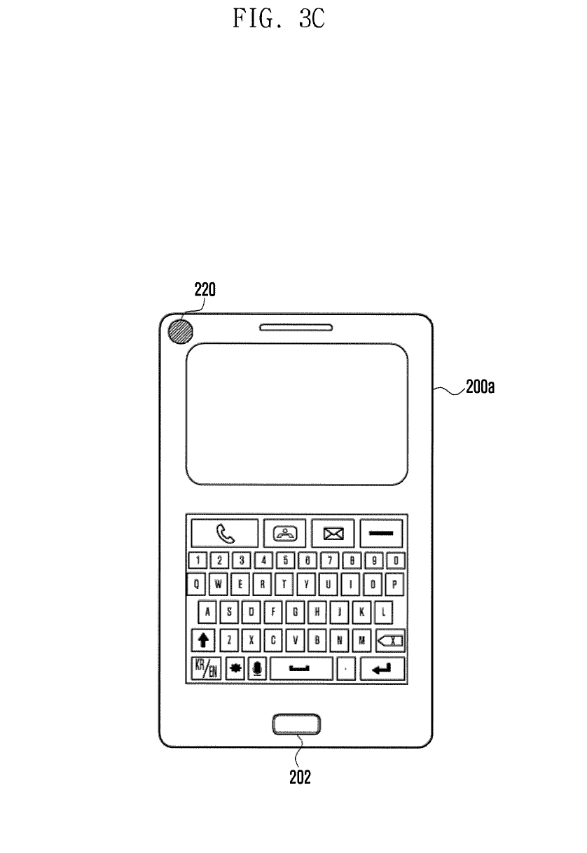

FIGS. 3A to 3C are diagrams schematically illustrating a configuration of a keypad cover according to an embodiment of the present disclosure.

Referring to FIGS. 3A and 3C, the keypad cover 200 can include a front surface 200a and a rear surface 200b.

FIG. 3A is an example of the keypad cover. The front surface 200a of the keypad cover can include an open area in a region of, and can include a closed area in another region. The open area can be formed of a transparent material. The closed area can include a keypad, and can be formed of a transparent, semitransparent, or opaque material. The keypad cover can include a shield film 210 on a portion of the front surface 200a, which contacts the electronic device.

In an embodiment of the present disclosure, If user input (for example, a touch input such as a touch, a double touch, a tab, a drag, a zoom-in, or a zoom-out) occurs while the front surface 200a is closed on touch screen, the keypad cover does not transmit a user input signal to the touch panel 131 through the shield film 210.

The keypad included in the closed area can be keypads having various forms. Here, the keypad can be any one of a QWERTY keypad, a 4*3 keypad, and other keypads having various input schemes. In addition, the keypad can include at least one function key. FIG. 3B is displays 200a detailed. FIG. 3B is an example of a front surface 200a including a Cheonjiin keypad. The keypad cover 200 can include a communication unit 220. If the touch screen 130 of the electronic device 100 is in contact (that is, the keypad cover 200 is closed), the communication unit 220 transmits keypad information to the electronic device 100. For example, the keypad information can be layout information of a 4*3 keypad (for example, a Cheonjiin keypad). The 4*3 keypad can physically have a button form. Here, the physical button can have an embossed portion as in 201, and can include a piezoelectric element, such that the user can detect the push of a button. The piezoelectric element is an element which converts pressure generated by an input of the user into an electrical signal. The physical button includes a letter area and at least one function key, and the letter area can have a depressed portion, an embossed portion, a hole, a boss, or a recess. Through this, the physical button can allow the user to recognize the button more easily. Because the keypad cover 200 includes at least one function key, it can perform functions that can be performed by a feature phone.

The front surface 200a can include a home key button 202, and the home key button can include a depressed portion, an embossed portion, a recess, and a hole.

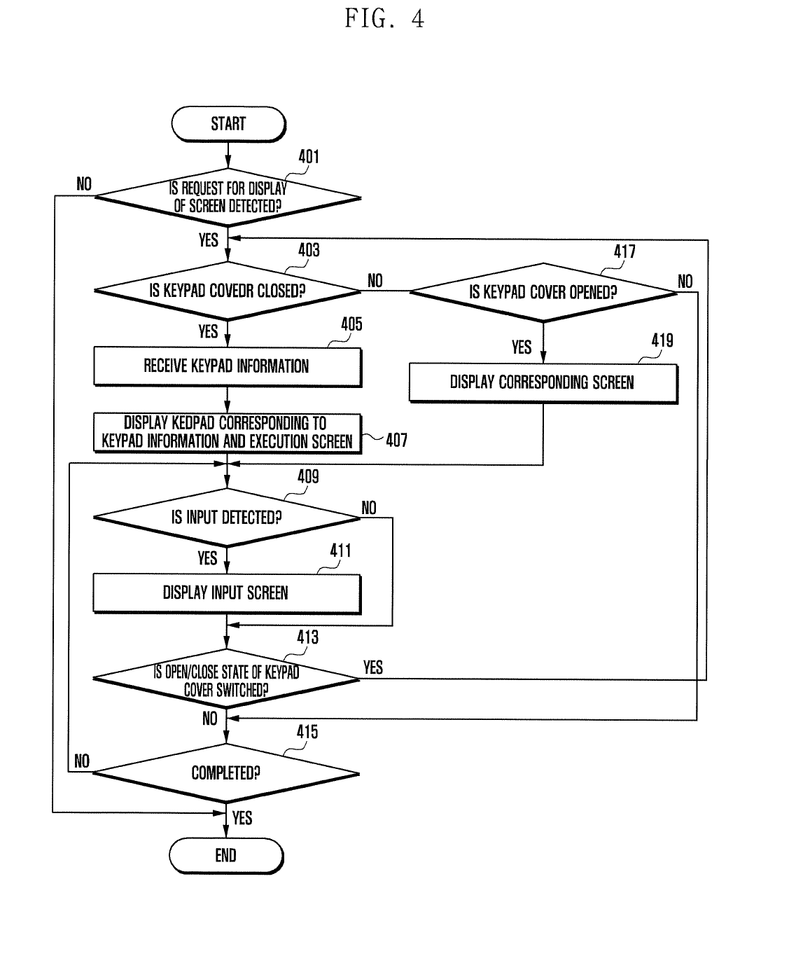

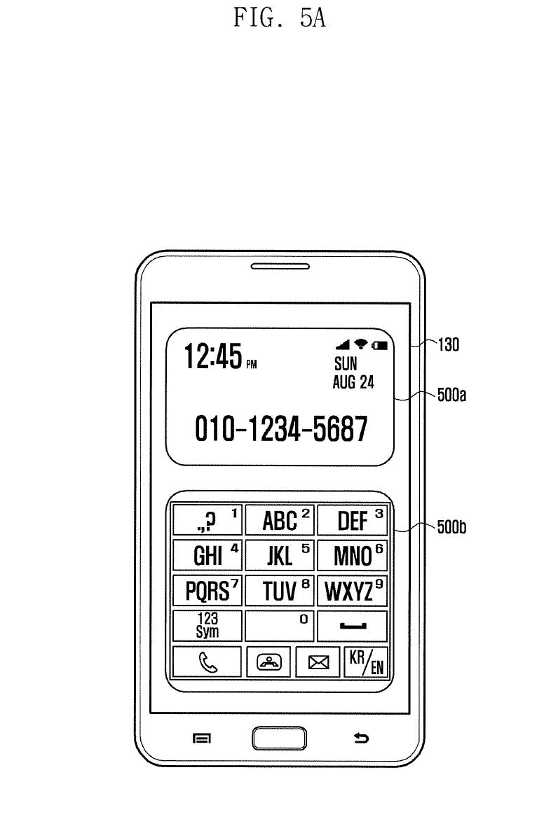

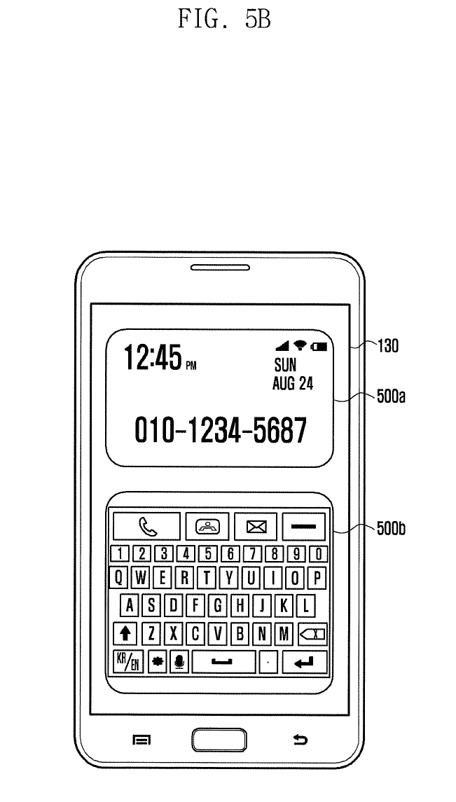

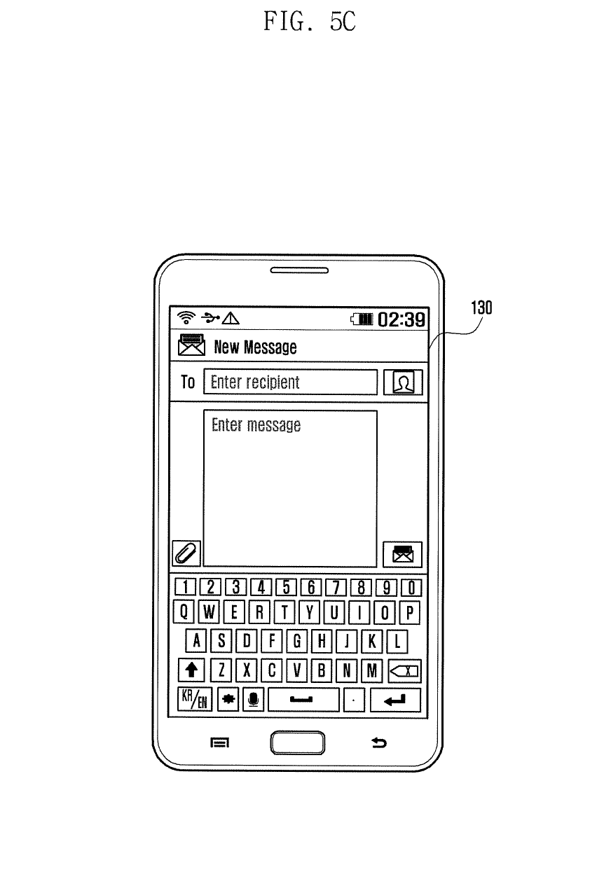

For example, the keypad included in the front surface 200a can be a QWERTY keypad as illustrated in FIG. 3C. FIG. 4 is a diagram illustrating a procedure of displaying a screen according to an open/closed state of the keypad cover by the electronic device according to an embodiment of the present disclosure. FIGS. 5A to 5C is a flowchart illustrating an example of displaying a screen according to an open/closed state of a keypad cover in an electronic device according to an embodiment of the present disclosure.

Referring to FIGS. 4 and 5A to 5C, the controller 140 can determine occurrence of a request for display of a screen in step 401. Here, the request for display of a screen can be a request for pushing any one of a home button or a power button while the display panel 132 is switched off, a request for supplying power by an earphone or a charging terminal, or a request by various push alarms such as a voice communication and reception of a message. If a request for the display of a screen occurs, the controller 140 detects occurrence of the request in step 401. Then, the controller 140 can determine the turning-on or off of the keypad cover 200 through the sensor unit 150 in step 403. If the keypad cover 200 is closed (that is, the front surface 200a is closed), the controller 140 can display an execution screen responding to user input in an area (that is, an area corresponding to an open area of the front surface 200a) of the displayed screen and can display a keypad corresponding to a key array of the keypad cover 200 in another area (that is, a keypad area of the front surface 200a). Then, the controller 140 receives keypad information corresponding to the key array from the communication unit 220 in step 405. The controller 140 can receive keypad information using a short distance wireless communication (for example, NFC). Here, the keypad cover information is layout information of various keypads, and for example, can be layout information of a QWERTY keypad, a 4*3 keypad, and keypads of various input schemes. If the keypad cover information is received, the controller 140 displays a virtual keypad corresponding to keypad information received in step 407 and an execution screen. When an execution screen corresponding to the keypad information is displayed, the controller 140 displays the execution screen in correspondence to an input of at least one function button included in the keypad. FIG. 5A illustrates an example of a screen for displaying Cheonjiin keypad information received from the communication unit 220. Referring to FIG. 5A, the controller 140 can display an execution screen (for example, a phone number input screen) in an area 500a of the displayed screen, and can display a keypad corresponding to a key array in another area 500b. Then, an area 500a of the screen can be an area corresponding to an open area of the keypad cover, and another area 500b can be an area corresponding to a keypad in a closed area of the keypad cover. The controller 140 displays the same keypad as the keypad of the keypad cover in another area 500b. Accordingly, if a key input is detected while the keypad is closed, the controller 140 can process the key input with key data. Referring to FIG. 5A, keypad information can be received and function buttons (for example, a voice communication completion button) can be displayed in another area 500b. The function keys displayed in the other area 500b can include various function keys (for example, direction keys, a voice communication key, a menu key, and a confirm key).

The controller 140 can be a QWERTY keypad in the other area 500b for displaying a keypad as illustrated in FIG. 5B, and the types of the displayed keypads are not limited thereto.

If a user input occurs in step 409 while the virtual keypad and the execution screen are displayed, the controller 140 detects the user input and processes the user input as key data. Here, the user input is detected through the keypad displayed in the area 500b, and is a touch input occurring on the keypad of the front surface 200a. That is, user input occurs on the keypad of the keypad cover 200, and the controller 140 detects the user input through the piezoelectric element of the keypad. Accordingly, the keypad (the keypad displayed on the touch screen) displayed below the keypad (for example, a 4*3 keypad) included on the front surface 200a of the keypad cover 200 is also operated in the same way such that a user input can be detected. If user input is detected, the controller 140 displays a screen responding to the user input in step 411. For example, the controller 140 displays an execution screen (for example, a screen where a phone number is pushed for a voice communication) in an area 500a of FIG. 5A. Thereafter, in step 413, a conversion to an open/closed state of the keypad cover 200 is examined. If a request for conversion to an open/closed state of the keypad cover is detected, the controller detects this in step 413 and returns to a step before step 403. If the keypad cover 200 is not closed, the controller 140 determines whether the keypad cover 200a is opened in step 417. If the keypad cover 200 is in an opened state (the keypad cover 200 is closed), an execution screen is displayed in the entire area of the displayed screen and the keypad set as in FIG. 5C can be displayed in the electronic device 100. Here, the set keypad is a keypad (for example, a QWERTY keypad) corresponding to a keypad input scheme that can be used by the user.

As the keypad cover 200 is switched between open and closed states, the controller 140 controls a display screen and a usage environment. If the keypad cover 200 is closed, the controller 140 provides a feature phone usage environment, and if the keypad cover 200 is opened, the controller can provide a smartphone usage environment. When the keypad cover 200 is closed to provide a feature phone usage environment, the controller 140 can display an execution screen in an area 500a and can display a keypad corresponding to the key array of the keypad cover 200 in another area 500b. Meanwhile, if the keypad cover 200 opened, an execution screen can be displayed in the entire area. This way, the controller 140 can control a display screen and an usage environment as the keypad cover 200 is switched on and off. In some embodiments, the keypad on the keypad cover is configured at the electronic device.

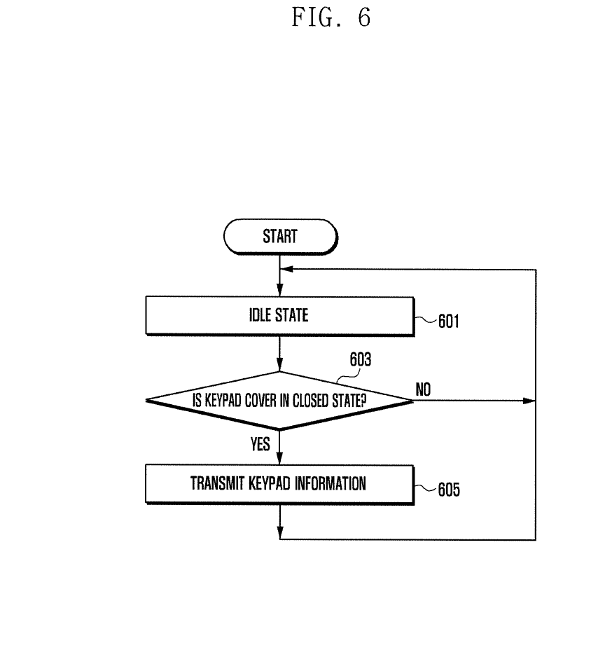

FIG. 6 is a flowchart illustrating a procedure of transmitting information of the keypad cover according to an open/closed state of the keypad cover, according to another embodiment of the present disclosure.

Referring to FIG. 6, if the keypad cover 200 comes into contact with the electronic device 100 to be connected to the electronic device 100, the keypad cover 200 can be in an idle state in step 601. The keypad cover 200 determines an open/closed state of the keypad cover in step 603 in an idle state. The keypad cover 200 can determine an open/closed state of the keypad cover 200 through a magnetic substance included in the front surface 200a. If the keypad cover 200 is in a closed state, the keypad cover 200 transmits keypad information to the electronic device 100 in step 605. That is, the communication unit 220 can transmit layout information of a keypad, for example, a QWERTY keypad, a 4*3 keypad, and keypads of various input schemes to the keypad cover information receiver 101. Meanwhile, if a closed state of the keypad cover 200 is not detected in step 605, the keypad cover 200 can return to a step before step 601 to be brought into an idle state.

The embodiments disclosed in the present specifications and drawings were provided merely to readily describe and to help a thorough understanding of the present disclosure but not intended to limit the scope of the present disclosure. Therefore, it should be construed that all modifications or modified forms drawn by the technical idea of the present disclosure in addition to the embodiments disclosed herein are included in the scope of the present disclosure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing a keypad for an electronic device, the method comprising:
upon a display event on a screen of the electronic device, identifying whether a keypad cover is open or closed;
in response to the keypad cover closed, displaying a key array on the keypad cover;
receiving a touch input detected on the displayed key array; and
processing the detected touch input to display the touch input on the screen.

2. The method of claim 1, further comprising:
displaying a keypad on the screen in response to the keypad cover open.

3. The method of claim 1, wherein the displaying the key array on the keypad cover comprises:
receiving a keypad information regarding a type of the key array; and
displaying a key array according to the type of the key array.

4. The method of claim 3, wherein the keypad information is received using a short distance wireless communication from the keypad cover.

5. The method of claim 1, further comprising detecting the touch input through a piezoelectric element of the keypad cover.

6. The method of claim 1, wherein being open or closed of the keypad cover is identified using a magnetic substance.

7. A method for providing a keypad for an electronic device, the method comprising:
detecting a keypad cover being open or closed; and
in response to the keypad cover closed,
transmitting keypad information regarding a key array to the electronic device from the keypad cover.

8. The method of claim 8, wherein the keypad cover comprises a shield film for shielding a user input signal on a surface in contact with the electronic device.

9. An apparatus for displaying a keypad, the apparatus comprising:
a keypad cover comprising:
a front surface formed of a transparent material and conductors disposed in a key array, for detecting a signal obtained through a touch on the keypad cover; and
a rear surface formed of an opaque material and mounted to the rear surface of the electronic device;
a sensor configured to detect one of open and closed states of the keypad cover;
a touch panel configured to detect a user input made through a touch on the keypad cover or the display panel;
a display panel configured to display an execution screen and a keypad; and
a controller configured to:
display a key array on the display unit when the keypad cover is opened;
display a keypad corresponding to the key array on the keypad cover when the keypad cover is closed, and
process a touch input detected by the touch panel.

10. The apparatus of claim 9, wherein the controller is configured to display a key array on the display panel in response to the keypad cover being open.

11. The apparatus of claim 9, wherein the keypad cover further comprises a communication unit configured to communicate with the electronic device, and wherein the keypad cover is configured to transmit a keypad information to the electronic device.

12. The apparatus of claim 9, wherein the keypad cover comprises a piezoelectric element, and a front surface of the keypad cover comes into contact with the display panel when the keypad cover is closed.

13. The apparatus of claim 9, wherein the touch panel is configured to detect a touch by the piezoelectric element when a touch occurs while the keypad cover is closed.

14. The apparatus of claim 9, wherein the controller is configured to receive the keypad information through the communication unit.

15. The apparatus of claim 9, wherein one of the open and close states of the keypad cover is detected through a magnetic substance.

16. The apparatus of claim 9, wherein the keypad cover comprises an open window area, and a keypad area with a debossed or embossed key array.

17. The apparatus of claim 9, wherein the keypad cover comprises a piezoelectric element that is a conductor on a front surface thereof.

18. The apparatus of claim 9, wherein the keypad cover is a flip-type cover.

19. The apparatus of claim 9, wherein the keypad corresponding to the key array which the received keypad information from the keypad cover.
